(19) United States
(12) Patent Application Publication
(10) Pub. No.: US 2003/0236158 A1
(43) Pub. Date: Dec. 25, 2003

(54) Method of and apparatus for producing a reclosable pouch

(76) Inventors: James C. Pawloski, Bay City, MI (US); Rui M. Pires, Midland, MI (US); Kenneth A. Toney, Baton Rouge, LA (US)

Correspondence Address: S.C. JOHNSON & SON, INC., 1525 HOWE STREET, RACINE, WI, 53403-2236, US

(21) Appl. No.: 10/178,301

(22) Filed: Jun. 24, 2002

(51) Int. Cl. B65D 33/16; B65D 33/00; B31B 1/82

(52) U.S. Cl. 493/394; 383/35; 383/63

(57) ABSTRACT

A method of producing a reclosable pouch includes the steps of extruding a bag web onto a casting roll and forming a closure profile on the bag web while the bag web is in contact with the casting roll. An apparatus for implementing the method is also disclosed.

### TECHNICAL FIELD

The present invention relates generally to reclosable pouches, and more particularly, to a method of and apparatus for manufacturing a thermoplastic bag.

### BACKGROUND ART

The use of reclosable thermoplastic bags for the storage of household items, such as food or other articles, is well known. An example of a reclosable thermoplastic bag is disclosed in Ausnit U.S. Pat. No. 5,259,904. The plastic bag includes thermoplastic bag walls of consistent thickness throughout. A closure profile comprised of male and female closure profile portions are disposed on internal portions of the bag walls. Two opposing lips with grip strips are disposed directly above the closure profiles. A user may place an item in the bag, interlock the closure profiles to close the bag, and re-open the bag using the grip strips to disengage the closure profiles.

There are several methods for manufacturing such reclosable thermoplastic bags. Known processes include the blown method, the cast integral method, and the cast post applied method. Bags manufactured by one of these methods may have characteristics that are different than bags made by another of these methods. Also, the production speeds are different and the costs associated with the methods vary widely.

The blown method is a two-up process that extrudes a cylindrical bag web of a single thickness simultaneously and integrally with two male and two female closure profiles. The two male profiles are disposed adjacent one another on an inside surface of the cylindrical bag web and the two female profiles are disposed adjacent one another on the inside surface of the web diametrically opposite the male profiles. As the bag web is extruded, air is blown into the interior thereof so that the thermoplastic is cooled. Thereafter, the bag web is slit between adjacent male and female closure profiles to form two web portions. The profiles of each web portion are then interlocked and the web portions are simultaneously severed and sealed at spaced locations by a hot wire resulting in individual reclosable thermoplastic bags. The production speed of the blown method is relatively slow as compared to other bag-making processes owing to the fact that the blown method utilizes convective cooling as opposed to conductive cooling. A bag manufactured by this method includes a bag web with a relatively uniform thickness throughout and, typically, lips of equal lengths. Any variation in the lip length or lip offset can be difficult to control using this manufacturing method.

The cast integral method includes the step of using a flat extrusion die to extrude the bag web and male and female closure profiles together in an integral fashion directly onto a temperature-controlled driven casting roll. The production speed of the cast integral process is approximately twice the speed of the blown method and the bag web extruded by the cast integral method is typically of a uniform thickness. However, because the profiles are extruded at the same time as the bag web and the profiles are located at the edges of the bag web, neck-in of the extrudate complicates the correct formation of the profiles.

The cast post applied method includes the steps of using a first extrusion die to extrude the bag web onto a casting roll and using one or more additional extrusion dies or other apparatus to extrude or adhere the closure profiles onto the bag web when the bag web is disposed at a location substantially downstream of the casting roll. An example of this method is disclosed in Geiger et al., U.S. Pat. No. 4,755,248. This method has the advantage of being operable at a production speed that is higher than the other two methods. In addition, the method can be used to produce bags having readily controllable portion dimensions and thicknesses.

It has been found that consumers prefer a bag having relatively thick top portions, even where a relatively high force is required to close the closure profiles of the bag, as compared with a bag having uniform wall thickness and a relatively lower required closing force. Also, it has been found that the lengths of the bag lips, as measured from the top of the bag to the closure profiles, as well as the difference between the lengths of the lips (i.e., the lip offset) and other dimensions have a significant impact on bag quality as perceived by consumers. These dimensions are most readily controlled in the cast post applied method, but some variability in these dimensions is encountered even in this process. Further, it has been found that the cost required to change over a cast integral production line to a cast post applied production line (which is the typical manner in which a cast post applied line is implemented) is extremely high due to the implementation cost of the required additional hardware components.

### SUMMARY OF THE INVENTION

According to one aspect of the present invention, a method of producing a reclosable pouch includes the steps of extruding a bag web onto a casting roll and separately forming a closure profile on the bag web while the bag web is in contact with the casting roll.

According to another aspect of the present invention, a method of producing thermoplastic bags includes the steps of extruding a web onto a casting roll wherein the bag web includes a top portion and a body portion and wherein the top portion has a thickness at least twice a thickness of the body portion and forming a closure profile on the top portion of the bag web while the bag web is in contact with the casting roll.

According to yet another aspect of the present invention, a storage bag is produced by a method comprising the step of extruding a bag web onto a casting roll wherein the bag web includes spaced top portions each of a first thickness and a body portion of a second thickness and wherein the first thickness is at least about 6 to 10 mils and the second thickness is in a range between about 1.5 mils and about 3.0 mils. The method further includes the steps of forming first and second closure profiles on the spaced top portions while the bag web is in contact with the casting roll and converting the bag web into individual storage bags.

In accordance with a still further aspect of the present invention, an apparatus for producing thermoplastic storage bags includes a casting roll and extrusion apparatus for extruding a bag web onto the casting roll, wherein the extrusion apparatus further forms a closure profile on the bag web after the bag web is formed while the bag web is in contact with the casting roll.

Still further in accordance with another aspect of the present invention, an apparatus for producing thermoplastic storage bags includes a casting roll and a first extrusion die for extruding a bag web onto the casting roll. An air knife is provided for pinning the bag web as a whole to the casting roll and second and third extrusion dies are provided for forming male and female closure profiles on the bag web while the bag web is in contact with the casting roll.

Other aspects and advantages of the present invention will become apparent upon consideration of the following detailed description.

### BRIEF DESCRIPTION OF THE DRAWINGS

FIG. 1 comprises an elevational view of a thermoplastic storage bag produced according to the present invention;

FIG. 2 comprises a sectional view of the thermoplastic storage bag taken generally along the lines 2-2 of FIG. 1;

FIG. 3 comprises an isometric view of apparatus according to the present invention;

FIG. 4 comprises an enlarged isometric view of the apparatus of FIG. 3;

FIG. 5 comprises an enlarged end elevational view of the apparatus of FIGS. 3 and 4;

FIG. 6 comprises an isometric view of a bag web produced by the apparatus of FIGS. 3-5 before folding thereof;

FIG. 7 comprises an isometric view of the bag web of FIG. 6 during folding thereof; and

FIG. 8 comprises a combined diagrammatic and block diagram of apparatus for forming individual bags from an elongate folded web of thermoplastic material.

### DESCRIPTION OF THE PREFERRED EMBODIMENTS

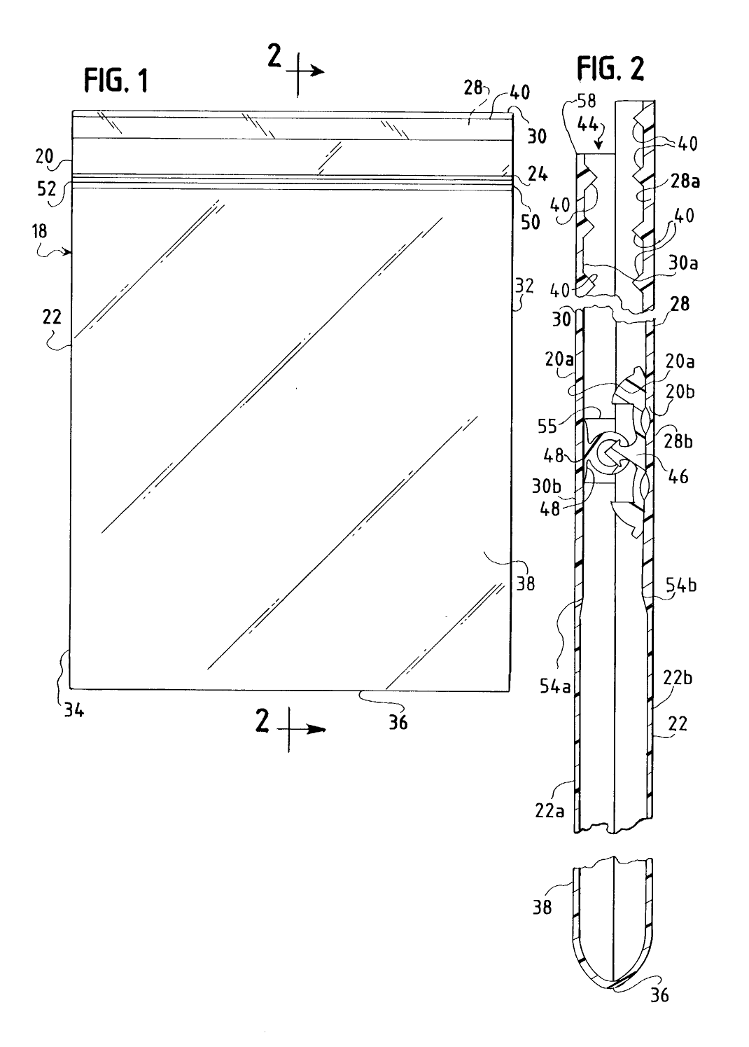

Referring now to FIGS. 1 and 2, a reclosable pouch in the form of a thermoplastic bag 18 comprises a top portion 20 integral with a body portion 22. The top portion 20 includes closure profiles 24 and first and second lips 28, 30. The bag 18 further includes a first sealed side 32, a second sealed side 34, and a bottom edge 36. The top portion 20 and the body portion 22 are formed from a thermoplastic bag web 38 produced in accordance with the method described hereinafter.

A plurality of grip strips 40 is disposed on the inner surfaces 28a, 30a of the first and second lips 28, 30, respectively. As seen in FIG. 2, the first and second lips 28, 30 form an opening 44 for placement of items therein. Disposed on the inner surface 28a of the first lip 28 is a male closure profile 46 while a female closure profile 48 is disposed on the inner surface 30a of the second lip 30. The male and female closure profiles 46, 48 extend from the first sealed side 32 to the second sealed side 34 parallel to the grip strips 40. A user may close the bag 18 by contacting outer surfaces 28b, 30b of the first and second lips 28, 30 over the profiles 46, 48 at an end 50 (FIG. 1) of the bag 18 using the thumb and a finger, pinching the lips 28, 30 such that the male closure profile 46 is inserted into the female closure profile 48 at the end 50 and sliding the thumb and finger across the bag 18 to an end 52 (FIG. 1), thereby interlocking the male and female closure profiles 46, 48 across the full width of the bag 18.

The method of the present invention is capable of producing bags of differing designs. For example, the method may be used to produce bags having a first thickness at the body portion 22 and a second thickness greater than the first thickness at the top portion 20. The thickness of each wall of the top portions 20a, 20b of the bag web 38 is preferably at least twice, and, more preferably, approximately 3-5 times the thickness of each wall of body portion 22a, 22b forming the body portion 22. According to a first design suitable for freezer bags, the thicknesses of the walls 22a, 22b are preferably (although not necessarily) equal to one another and each wall 22a, 22b preferably has a thickness in a range between approximately 1.5 and approximately 3.0 mils, with a thickness between approximately 2.55 mils and 2.90 mils being more preferred and a thickness of approximately 2.70 mils being most preferred. Still further, the thicknesses of the walls 20a, 20b are preferably (although not necessarily) equal to one another and each wall 20a, 20b is of a thickness between approximately 5 and approximately 15 mils, with a thickness of approximately 10 to approximately 13 mils being more preferred and a thickness of approximately 12 mils being most preferred. In a second design suitable for storage bags, the thicknesses of the walls 22a, 22b are preferably (although not necessarily) equal to one another and each wall 22a, 22b preferably has a thickness in a range between approximately 1.0 and approximately 3.0 mils with a thickness of 1.75 mils being most preferred. Also in this design, the thicknesses of the walls 20a, 20b are preferably (although not necessarily) equal to one another and each wall 20a, 20b is of a thickness between approximately 5 and approximately 15 mils with a thickness of 10 mils being most preferred. In a third design suitable for sandwich bags, the thicknesses of the walls 22a, 22b are preferably (although not necessarily) equal to one another and each wall 22a, 22b preferably has a thickness in a range between approximately 0.5 and approximately 1.5 mils with a thickness of 1.00 mil being most preferred. In addition, the thicknesses of the walls 20a, 20b are preferably (although not necessarily) equal to one another and each wall 20a, 20b is of a thickness between approximately 2 and approximately 5 mils with a thickness of 3-4 mils being most preferred. It should be evident to one of ordinary skill in the art that the foregoing ranges and preferred values may be varied, as desired.

Each wall 20a, 20b is joined to an associated wall 22a, 22b, respectively, at a transition portion 54a, 54b. Preferably, although not necessarily, the transition portions 54a, 54b are of equal lengths (i.e., they extend equal distances from the top to the bottom of the bag 18 as seen in FIG. 2) and the thicknesses thereof preferably taper uniformly and continuously from the wall 20a, 20b to the associated wall 22a, 22b. Also preferably, the transition portions 54a, 54b are relatively short and are disposed at substantially equal heights (as seen in FIG. 2) above the bottom edge 36 of the bag 18, although the transition portions 54a, 54b may be disposed at unequal heights above the bottom edge 36 of the bag 18, if desired.

As seen in FIG. 2, the first and second lips 28, 30 are preferably of differing lengths to create an offset wherein the magnitude of the offset is the difference between the length of the first lip 28, as measured from a top 55 of the female profile 48 to an upper edge 56 of the first lip 28, and the length of the second lip 30, as measured from the top 55 of the female profile 48 to an upper edge 58 of the second lip 30, while the profiles 24 are closed. Preferably, the lip 30 has a length of approximately 0.50-0.80 inch, and more preferably has a length of 0.65-0.75 inch, and most preferably has a length of 0.70 inch. Further, the lip 28 preferably has a length of approximately 0.825 inch, thereby establishing a preferred offset of approximately 0.125 inch, although the offset can be established at a different value by adjusting the positions of a male profile 46 and the female profile 48 below the upper edges 56, 58. Also, preferably, the transition portions 54a, 54b are centered at a distance between 0.75 inch and 2.00 inches below the upper edge 58 of the lip 30, with a distance of about 1.00 and 1.50 inch being more preferred, and a distance of about 1.25 inch being most preferred.

The grip strips 40 preferably extend parallel to the bottom edge 36 of the bag 18 from the first sealed side 32 to the second sealed side 34. Preferably, the grip strips are manufactured in accordance with the teachings of McCree U.S. Pat. No. 5,009,828, owned by the assignee of the present application and the disclosure of which is incorporated by reference herein. A user grasps the lips 28 and 30 during opening of the bag 18 and the grip strips 40 help prevent the fingers and/or thumbs of the user from sliding off the lips 28 and 30.

In the illustrated embodiment, the interlocked male and female closure profiles 46, 48 and the first and second lips 28, 30 have a combined thickness of approximately 65 to approximately 125 mils, with approximately 90 to approximately 105 mils being more preferred and approximately 94 mils being most preferred.

Still further in accordance with the illustrated embodiment, the male and female closure profiles 46, 48 may have the configuration disclosed in Fisher, et al. U.S. Pat. No. 4,736,496 or Porchia, et al. U.S. Pat. No. 5,012,561, both owned by the assignee of the present application and the disclosures of which are incorporated by reference herein.

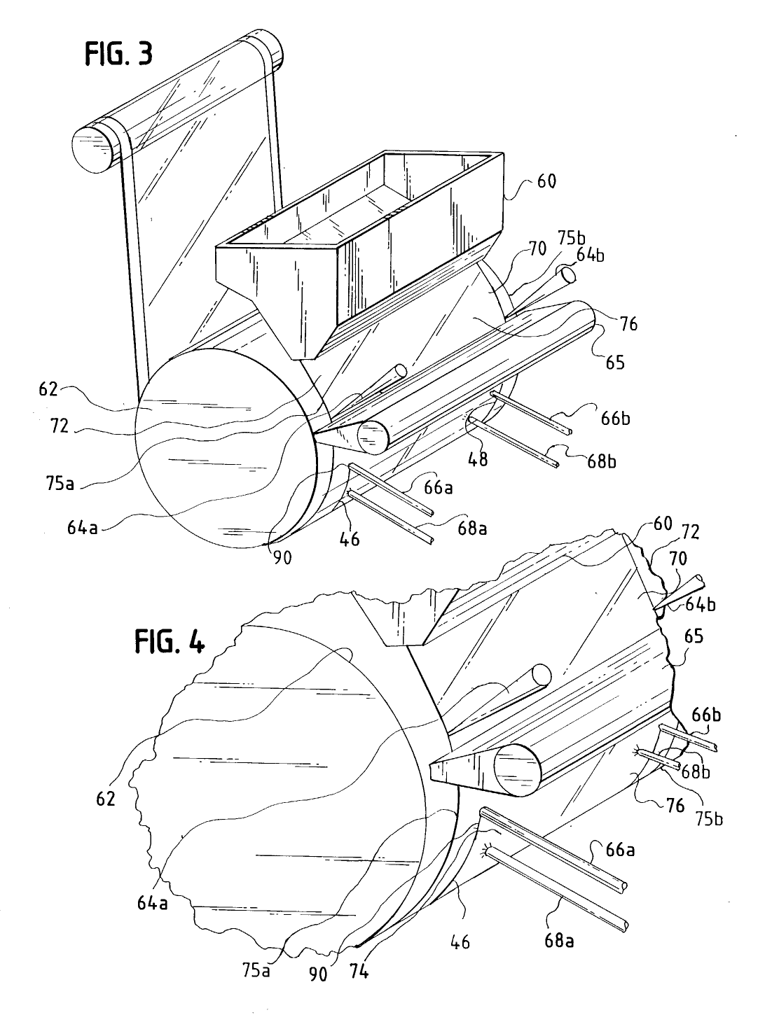

Referring next to FIGS. 3 and 4, bags such as the bag 18 are produced according to a production method according to the present invention that utilizes extrusion apparatus including a first extrusion slot die 60, a temperature-controlled driven casting roll 62, edge pinning devices or apparatus 64a, 64b, an air knife 65, second and third extrusion dies 66a, 66b (which, together with the die 60, form the extrusion apparatus) and cooling apparatus 68a, 68b. The extrusion die 60 receives molten thermoplastic from an extruder (not shown) and deposits the thermoplastic in sheet form as a web 70 onto the casting roll 62. The extrusion die 60 includes a slot opening (not shown) that forms thickened areas 72, 74 at outside edge portions 75a, 75b of the resulting web 70 and a relatively thinner portion 76 intermediate the thickened areas 72, 74. The edge portions 75a, 75b are pinned to the casting roll 62 by the edge pinning devices 64a 64b, respectively. The web 70 is then pinned across the entire width thereof (i.e., as a whole) to the casting roll 62 by the air knife 65.

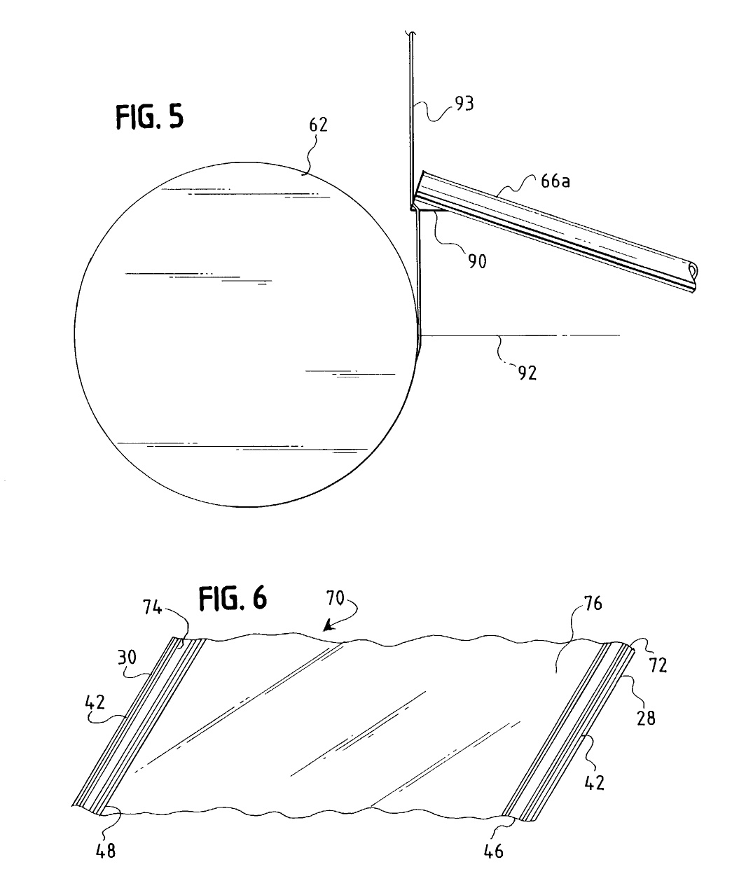

After the web 70 is pinned to the casting roll 62, the male and female closure profiles 46, 48 are formed on the web 70. Preferably, the extrusion dies 66a, 66b receive molten thermoplastic from separate extruders and extrude the male and female closure profiles 46, 48, respectively, onto the thickened areas 72, 74. Alternatively, the separate extrusion dies 66a, 66b may be replaced by a single extrusion die having two outlets at which the male and female closure profiles 46, 48 are simultaneously extruded onto the thickened areas 72, 74. In any event, as seen in FIG. 5, the angle of a face 90 of each die 66 is at least initially disposed substantially parallel to a horizontal (as seen in FIG. 5) radial line 92 extending from the center of the casting roll 62. The position of the die 66 (or each die 66a, 66b individually if separate dies are used) may then be adjusted by moving the die left, right, up, or down (all as seen in FIG. 5) or the die may be tipped (i.e., angularly displaced) to adjust the angle of the die face 90 to obtain desirable results. The closure profiles 24 formed by the die(s) 66 may exit the die(s) 66 at a point coincident with a vertical tangent line 93 (FIG. 5) intersecting the surface of the casting roll 62 on the side of the casting roll 62 where the web 70 is first deposited thereon. Alternatively, the closure profiles 24 formed by the die(s) 66 may exit the die(s) 66 at a point displaced to the right or left (as seen in FIG. 5) of the tangent line 93. If the extrudate exits the die(s) 66 at a point displaced to the right of the line 93, some provision must be made at the initiation of production to attach the extrudate stream to the casting roll 62. Thereafter, production may commence, (provided that the exit of the die(s) 66 is not disposed too far to the right of the tangent line 93) whereupon the melt strength of the extrude stream carries the stream into contact with the roll 62.

Once the molten thermoplastic from the die(s) 66 has been deposited onto the web 70, coolant is applied to the profiles 46, 48 by the coolant apparatus 68a, 68b to bring the temperature thereof below the melting point of the thermoplastic material forming the profiles 46, 48 as quickly as possible. Preferably, the coolant comprises water or any other suitable cooling fluid and the coolant is applied to the material of the profiles 46, 48 only after such material contacts the material of the web 70 so that adhesion thereto is optimized. The web 70 and the closure profiles 46, 48 are maintained in contact with the temperature-controlled casting roll 62 for a period of time as the roll 62 is rotated so that the web 70 and profiles 46, 48 are further cooled. The casting roll 62 should be maintained at a temperature below the melting point of the thermoplastic material(s) forming the web 70 and the closure profiles 46, 48, typically about 20-80 degrees C.

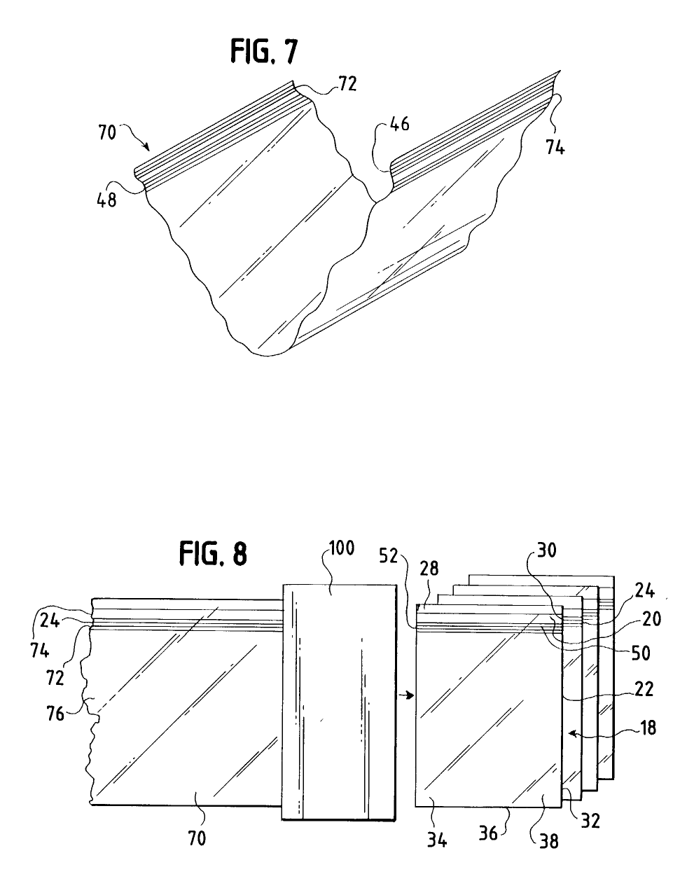

Thereafter, the coolant that was applied to the closure profiles 46, 48 is removed by any conventional method, such as by any known dewatering process. The method results in the production of an elongate web 70 with closure profiles 46, 48 applied thereto, a section of which is seen in FIG. 6. Subsequently, as seen in FIG. 7, the elongate web 70 is folded longitudinally by any suitable apparatus and the elongate folded web 70 is sealed and cut at spaced points thereof by a hot wire, a hot knife or any other conventional apparatus 100 (FIG. 8) to form individual bags. Alternatively, the elongate web 70 could be wound on one or more rolls and processed at a later point (i.e., off-line) to create individual bags.

### INDUSTRIAL APPLICABILITY

The method and apparatus of the present invention are useful to extrude the web 70 and apply the male and female profiles 46, 48 in a single unit operation. This eliminates a unit operation, as compared with the cast post applied process described above, where the closure profiles 24 are applied separate from the point at which the web 70 is extruded. Because a unit operation is eliminated a significant savings is realized in terms of the conversion costs from a cast integral line.

The method and apparatus of the present invention also have the advantage of relatively fast production rates (approximately 10% faster than the cast integral method) and avoid the controllability issues encountered by the cast integral method. The method of the present invention also avoids the variability in lip length encountered by the cast post applied method. In addition, the method disclosed herein can be used to produce bags having the dimensions noted above. It has been found that such bags are preferred by most consumers, presumably due to the relatively thicker bag tops, which create the perception that the closure profiles 46, 48 are substantially self aligning, thereby facilitating closure of the bag 18, when desired, without substantial wasted effort on the part of the consumer.

In addition to the foregoing, the relatively thick walls 20a, 20b of the top portion 20 cause such walls to have a haze at the top portion 20. It has been found that consumers find such hazy appearance to be a desirable attribute, apparently for the reason that the hazy appearance connotes strength and durability. Still further, the relatively thick portions at the bag tops apparently create the perception that the entire bag is of durable and sturdy construction perhaps because the bag walls are thickest where the bag is most often handled by the consumer.

The method and apparatus of the present invention as described herein may be modified as desired. For example, the profiles 46, 48 may be extruded at a location above the air knife 65 and may be attached onto the web 70 either at or below the point at which the web 70 is pinned by the air knife 65. Also, the first though third extrusion dies 60, 66a and 66b may be replaced by a single extrusion die or multiple extrusion dies.

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out the same. The exclusive rights to all modifications that come within the scope of the appended claims are reserved.

We claim:

1. A method of producing a reclosable pouch, the method comprising the steps of:
extruding a bag web onto a casting roll; and
separately forming a closure profile on the bag web while the bag web is in contact with the casting roll.

2. The method of claim 1, wherein the step of extruding the bag web comprises the step of depositing plastic film including a first section having a first thickness and a second section having a second thickness thinner than the first thickness.

3. The method of claim 2, wherein the step of depositing the plastic film comprises the step of forming the first section at a top portion of the bag web.

4. The method of claim 2, wherein the step of depositing the plastic film comprises the step of forming the second section at a body portion of a bag web.

5. The method of claim 3, further comprising the step of pinning the top portion to the casting roll.

6. The method of claim 1, further comprising the step of controlling the temperature of the casting roll.

7. The method of claim 1, wherein the step of forming comprises the step of extruding the closure profile.

8. The method of claim 7, wherein the step of extruding the closure profiles includes the step of using an extrusion die.

9. The method of claim 8, further comprising the step of disposing a face of the extrusion die parallel to a line extending from a center of the casting roll.

10. The method of claim 1, wherein the step of forming includes the step of using an air knife.

11. The method of claim 10, further comprising the step of extruding the closure profile onto the bag web at a location adjacent to the air knife.

12. The method of claim 1, further comprising the step of pinning the bag web as a whole to the casting roll.

13. The method of claim 1, further comprising the step of applying a coolant to the closure profile after the closure profile is applied to the plastic film.

14. A method of producing thermoplastic bags, the method comprising the steps of:
extruding a web onto a casting roll wherein the bag web includes a top portion and a body portion and wherein the top portion has a thickness at least twice a thickness of the body portion; and
forming a closure profile on the top portion of the bag web while the bag web is in contact with the casting roll.

15. The method of claim 14, further comprising the step of pinning the top portion to the casting roll.

16. The method of claim 14, further comprising the step of controlling the temperature of the casting roll.

17. The method of claim 14, wherein the step of forming a closure profile onto the bag web comprises the step of extruding the closure profile.

18. The method of claim 17, wherein the step of extruding the closure profile includes the step of using an extrusion die.

19. The method of claim 18, further comprising the step of disposing a face of the extrusion die parallel to a line extending from a center of the casting roll.

20. The method of claim 14, wherein the step of forming includes the step of using an air knife.

21. The method of claim 20, further comprising the step of extruding the closure profile at a location adjacent to the air knife.

22. The method of claim 14, further comprising the step of pinning the bag web as a whole to the casting roll.

23. The method of claim 14, further comprising the step of cooling the closure profile with coolant after the closure profile is applied to the plastic film.

24. A storage bag produced by a method comprising the steps of:
extruding a bag web onto a casting roll wherein the bag web includes spaced top portions each of a first thickness and a body portion of a second thickness different than the first thickness;
forming first and second closure profiles on the spaced top portions while the bag web is in contact with the casting roll; and
converting the bag web into individual storage bags.

25. The storage bag produced by the method of claim 24, wherein the step of extruding results in creation of a haze on the top portion.

26. The storage bag produced by the method of claim 24, further comprising the step of pinning the top portions to the casting roll.

27. The storage bag produced by the method of claim 24, further comprising the step of controlling the temperature of the casting roll.

28. The storage bag produced by the method of claim 24, wherein the step of forming the closure profiles onto the bag web comprises the step of extruding the closure profiles.

29. The storage bag produced by the method of claim 28, wherein the step of extruding the closure profiles includes the step of using an extrusion die.

30. The storage bag produced by the method of claim 29, further comprising the step of disposing a face of the extrusion die parallel to a line extending from a center of the casting roll.

31. The storage bag produced by the method of claim 24, wherein the step of extruding the closure profiles includes the step of forming lips.

32. The storage bag produced by the method of claim 31, wherein the step of forming the lips includes the step of extruding gripper strips on the lips.

33. The storage bag produced by the method of claim 24, wherein the step of forming includes the step of using an air knife.

34. The storage bag produced by the method of claim 33, further comprising the step of extruding the closure profiles at a location adjacent to the air knife.

35. The storage bag produced by the method of claim 24, further comprising the step of pinning the bag web as a whole to the casting roll.

36. The storage bag produced by the method of claim 24, further comprising the step of applying a coolant to the closure profiles after the closure profiles are applied to the plastic film.

37. The storage bag produced by the method of claim 24, wherein the step of forming comprises the step of depositing the first and second closure profiles on the spaced top portions.

38. The storage bag produced by the method of claim 24 wherein the step of converting includes the step of using a cutting and sealing apparatus.

39. The storage bag produced by the method of claim 38, further comprising the step of creating a body portion with a thickness of 1.5 to 3.0 mils.

40. The storage bag produced by the method of claim 38, wherein the first thickness is in a range between about 5 to 15 mils and the second thickness is in a range between about 1.5 mils and about 3.0 mils.

41. The storage bag produced by the method of claim 38, wherein the step of cutting and sealing includes the step of using a hot wire.

42. The storage bag produced by the method of claim 41, wherein the step of using a hot wire includes the step of cutting the bag web.

43. The storage bag produced by the method of claim 41, wherein the step of using a hot wire includes the step of sealing the bag web.

44. Apparatus for producing thermoplastic storage bags, comprising:
a casting roll; and
extrusion apparatus for extruding a bag web onto the casting roll, the extrusion apparatus further forming a closure profile on the bag web after the bag web is formed while the bag web is in contact with the casting roll.

45. The apparatus of claim 44, wherein the extrusion apparatus includes first, second and third extrusion dies.

46. The apparatus of claim 44, further including an air knife for pinning the bag web.

47. The apparatus of claim 46, wherein the closure profile is formed on the bag web after the bag web is pinned by the air knife.

48. The apparatus of claim 46, wherein the closure profile is formed on the bag web at a location where the bag web is pinned by the air knife.

49. The apparatus of claim 44, further including edge pinning devices for pinning edge portions of the bag web.

50. The apparatus of claim 49, further including an air knife for pinning the bag web as a whole onto the casting roll after the edge portions are pinned.

51. The apparatus of claim 50, wherein the closure profile is formed on the bag web after the bag web is pinned as a whole onto the casting roll by the air knife.

52. The apparatus of claim 51, wherein coolant is applied to the closure profile after the closure profile is formed on the bag web.

53. Apparatus for producing thermoplastic storage bags, comprising:
a casting roll;
a first extrusion die for extruding a bag web onto the casting roll;
an air knife for pinning the bag web as a whole to the casting roll; and
second and third extrusion dies for forming male and female closure profiles on the bag web while the bag web is in contact with the casting roll.

54. The apparatus of claim 53, further including edge pinning devices for pinning edge portions of the web to the casting roll before the bag web is pinned as a whole by the air knife.

55. The apparatus of claim 54, wherein the closure profiles are formed on the bag web after the bag web is pinned by the air knife.

56. The apparatus of claim 54, wherein the closure profiles are formed on the bag web at a location where the bag web is pinned by the air knife.

57. The apparatus of claim 54, wherein coolant is applied to the closure profiles after the closure profiles are formed on the bag web.
